(19) United States
(12) Patent Application Publication
(10) Pub. No.: US 2004/0218613 A1
(43) Pub. Date: Nov. 4, 2004

(54) Communicating diagnostic information of an active modem session to an online service

(76) Inventor: Peter A. Fortman, Leesburg, VA (US)

Correspondence Address: FISH & RICHARDSON P.C., 1425 K STREET, N.W., 11TH FLOOR, WASHINGTON, DC, 20005-3500, US

(21) Appl. No.: 10/821,181

(22) Filed: Apr. 9, 2004

Related U.S. Application Data
(60) Provisional application No. 60/461,425, filed on Apr. 10, 2003.

(51) Int. Cl. H04L 12/66

(52) U.S. Cl. 370/401

(57) ABSTRACT

Communicating diagnostic information to an online service may include communicating with a plurality of user computers having a plurality of modem access sessions. The online service may communicate with the user computers using one or more gateways. For example, each access session may include a first communication session between the online service and a gateway, and a second communication session between the gateway and a modem of a user computer. Each gateway may gather diagnostic information indicative of corresponding second communication sessions. The diagnostic information may be communicated to the online service using the first communication sessions. The online service may use the diagnostic information automatically to detect or to diagnose a communication fault.

### CLAIM OF PRIORITY

This application claims priority under 35 USC § 119(e) to U.S. Provisional Patent Application Serial No. 60/461,425, filed on Apr. 10, 2003, the entire contents of which are hereby incorporated by reference.

### BACKGROUND

Users may access online services by establishing a communication channel that leverages a modem or other connectivity device of an online access provider. Various faults may occur in the communication channel to interrupt the access of the user to an online service. In particular, the modem connection of the user may be vulnerable to disruption as the modem connection typically traverses a “first mile” network. “First mile” networks typically include elements of the plain old telephone service, an often antiquidated network designed primarily for low-bandwidth voice communication rather than high quality voice and/or data communication.

Yet diagnostic information regarding the modem sessions of a remote user is generally not readily available to the providers of online services. Lacking this diagnostic information, online services are handicapped in making determinations regarding communication channel maintenance and in managing the quality of service provided to remote users.

### DESCRIPTION OF DRAWINGS

FIG. 1 is a schematic diagram of a system for communicating diagnostic information of an active modem session to an online service over a public network.

FIG. 2 is a schematic diagram of a system, as in FIG. 1, that uses a point-to-point tunnel to communicate diagnostic information of an active PSTN modem session.

FIG. 3 is a schematic diagram of a system, as in FIG. 1, that uses a point-to-point tunnel to communicate diagnostic information of an active xDSL modem session.

FIG. 4 is a schematic diagram of a system similar to the system of FIG. 1 that includes multiple active modem sessions.

### DESCRIPTION

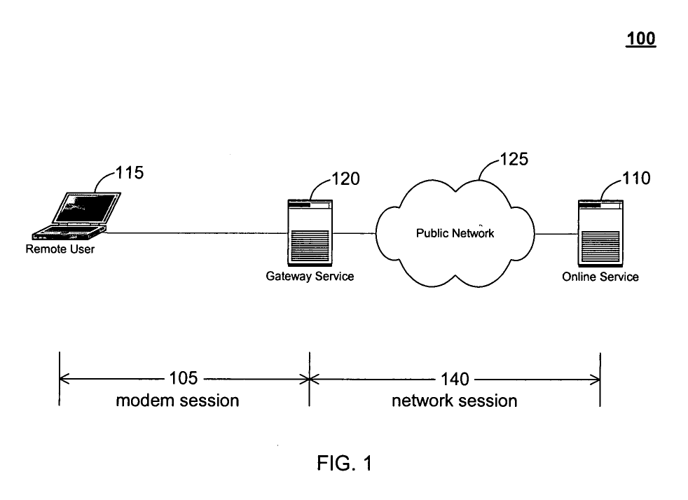

FIG. 1 illustrates a generalized system 100 that may be used to communicate diagnostic information of an active modem session 105 to an online service 110. A remote user 115 establishes the active modem session 105 with a gateway service 120. The gateway service 120, in turn, provides the remote user 115 with access to the online service 110 over a public network 125 using a network session 140. In other words, the gateway service 120 acts as an intermediary between two distinct communication sessions, the active modem session 105 and the network session 140, that together enable communication between the remote user 115 and the online service 110.

To enhance service quality to the remote user 115, status information is relayed from the modem session 105 to the online service 110 using the network session 140. For instance, the gateway service 120 determines diagnostic information related to the active modem session 105, and communicates the diagnostic information to the online service 110 over the public network 125 using the network session 140. The online service 110 may make a maintenance determination based on the diagnostic information. Exemplary components of the system 100 are described in greater detail below.

The remote user 115 generally may include any device, system, and/or piece of code configured to access the online service 110. For example, the remote user 115 may include a mobile device such as a notebook computer, a workstation, a pen-enabled computer, a mobile telephone, and/or a personal digital assistant (PDA). The remote user 115 also may include a software application, such as, for example, a Web browser, an email application, a file transfer application, and/or an operating system or operating system kernel residing on a hardware device.

The remote user 115 may include a hardware and/or software implementation of a modem. The modem may be configured, for example, to communicate data over a wired or wireless telephone network, and/or a cable network. More specifically, the modem may be configured to communicate data using plain old telephone service (POTS), a digital subscriber line (xDSL), an integrated services digital network (ISDN), or a data over cable service interface (DOCSI). The modem may be configured to transmit data using one or more data transmission protocols that may include one or more data compression and/or error correction algorithms. The data transmission protocols also may define a training/retraining process to allow the modem to negotiate data transmission parameters with, for example, the gateway service 120 or another participant of the active modem session 105.

The gateway service 120 is configured to facilitate communication between the remote user 115 and the online service 110 using the active modem session 105 and the network session 140 over the public network 125. To this end, the gateway service 120 is configured to communicate using protocols associated with the active modem session 105 (e.g., POTS, xDSL, ISDN, DOCSI), and also using underlying protocols associated with the public network and the online service. With respect to the public network 125, for example, the gateway service 120 may be configured to communicate using the internet protocol (IP) and other associated protocols (e.g., the transport connection protocol (TCP), the user datagram protocol (UDP)). The gateway service 120 may communicate with the online service 110 over the public network 125 using a point-to-point tunneling protocol (e.g., the layer 2 tunnel protocol (L2TP), layer 2 forwarding (L2F), or the point-to-point tunneling protocol (PPTP)) to establish the network session 140.

The gateway service 120 also may be configured to determine diagnostic information related to the active modem session 105. The gateway service 120 may determine the diagnostic information using, for example, line probing of a communication channel associated with the active modem session 105. The diagnostic information may include, for example, modulation parameters (e.g., a modulation rate, a center frequency, a power level), a modem retrain incidence (e.g., a total retrain incidence, an incidence of remote user initiated retrains, an incidence of gateway service initiated retrains), a signal-to-noise ratio (SNR), an error frequency, an echo loss, a trip delay, a symbol rate, a data rate, a frequency of correctable errors, a frequency of uncorrectable errors, a bandwidth, a spectral shape associated with the bandwidth, and/or a measure of harmonic distortion. The gateway service 120 may communicate the diagnostic information to the online service 110 over the network session 140 using protocols of the online service 110 and the public network 125.

The public network 125 typically allows direct or indirect communication between the gateway service 120 and the online service 110 irrespective of physical or logical separation. The public network 125 may be unsecured, and messages transported over the public network 125 (e.g., using the IP) may be subject to interception, eavesdropping or counterfeiting unless, for example, the network session 140 uses a point-to-point tunnel protocol (e.g., L2TP) to encrypt and/or encapsulate communicated messages.

The online service 110 generally may include, for example, any device, system, and/or piece of code configured to perform an operation requested by the remote user 105. The online service 110 typically includes different services and sources of information, such as, for example, a third party information source or service, an email service, a discussion group, a chat room, a news service, a broker service, a banking service, a shopping service, a weather service, the World Wide Web, or an internet access providing service. The online service 110 may employ one or more protocols (i.e., standards, formats, conventions, rules, and structures) to transfer information internally or to deliver information to the remote user 105. Protocols employed by the online service 110 may include the internet protocol, the transfer connection protocol, the hypertext transfer protocol (HTTP), the file transfer protocol (FTP), the user datagram protocol, the layer two tunneling protocol and/or the simple mail transfer protocol (SMTP).

Each component of system 100 may further include various mechanisms for delivering data, such as, for example, the short message service (SMS), the wireless application protocol (WAP), the transport connection protocol (TCP), the internet protocol, the World Wide Web, one or more local area networks (LANs) and/or one or more wide area networks (WANs). The system components also may include analog or digital wired and wireless telephone networks, e.g., public switched telephone networks, integrated services digital networks, various types of digital subscriber lines, advance mobile telephone service (AMPS), global system for mobile communications (GSM), general packet radio service (GPRS), code division multiple access (CDMA), radio, cable, satellite, and/or other delivery mechanisms for carrying data.

One or more other services may be included in the components of system 100 and/or these components (hereinafter the system services) may be included as part of one or more other services. For example, the system services may include or be included in a general-purpose or a special-purpose computer (e.g., a personal computer, a PDA, or a device specifically programmed to perform certain tasks), at least one Local Area Network (LAN), and/or at least one Wide Area Network (WAN). Either way, the response to and execution of instructions received by any or all of the system services may be controlled by, for example, a program, a piece of code, an instruction, a device, a computer system, or a combination thereof, for independently or collectively instructing the services to interact and operate as described herein.

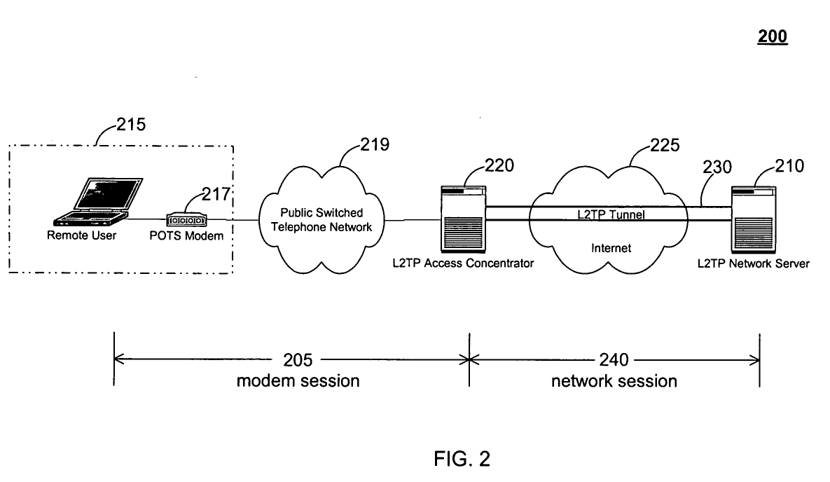

FIG. 2 illustrates a system 200 that may be used to implement the concepts described with respect to the system of FIG. 1. A remote user 215 establishes an active analog modem session 205 (active modem session) with an L2TP access concentrator (LAC) 220 using a public switched telephone network (PSTN) 219. LAC 220 operates as a gateway service (e.g., 120 of FIG. 1) such that the active modem session 205 connects the remote user 215 and the LAC 220. The remote user may use a POTS (plain old telephone service) modem 217 to dial into the LAC over the PSTN 219. To further clarify the nature of the active modem session 205, the POTS modem 217 is shown as a component of the remote user 215.

The online service 110 may include an L2TP network server (LNS) 210. The LAC 220 and the LNS 210 may communicate data (e.g., communications of the remote user 115 and the LNS 210) using, for example, a public network such as the internet 225. The LAC 220 and the LNS 210 may establish a point-to-point tunnel (e.g., L2TP tunnel 230) using, for example, the L2TP. The LAC 220 and the LNS 210 then use the L2TP tunnel 230 to communicate data to or from the remote user 215, or to communicate other data, such as, for example, the diagnostic information related to the active modem session 205.

To communicate information using the L2TP tunnel 230, the LAC 220 and the LNS 210 encapsulate L2TP packets within TCP/P packets carried by the internet. The L2TP specifies that encapsulation within a TCP/IP packet is not direct. Rather, an L2TP packet first is encapsulated within at least one packet of a type associated with Layer 2 of the OSI (open system interconnection) model (a layer 2 packet). Exemplary layer 2 packets include a user data packet (UDP), a frame relay packet, or an ATM (asynchronous transfer mode) cell. The layer 2 packet(s) encapsulating the L2TP packet then are encapsulated themselves within a TCP/IP packet.

L2TP includes two different packet types: control messages and data messages. Communications between the remote user 215 and the LNS 210 through the L2TP tunnel are transported as data messages. On the other hand, control messages may be used by the LAC 220 and/or by the LNS 210 to establish, maintain, and dismantle the L2TP tunnel 230. Additionally, the LAC 220 may use a control message to communicate the diagnostic information to the LNS 210.

Conventional L2TP control message definitions may be supplemented to enable transport of diagnostic information related to an active modem session. More explicitly, a custom control message may be defined for transport of modem session diagnostic information.

Parameters of a control message header may identify the control message as a custom control message configured to transport modem session diagnostic information. Two control message header parameters may be useful to provide that identification. Those parameters are “attribute type” and “vendor ID.” The “attribute type” parameter is used to identify a control message type unique within a given “vendor ID.” The “vendor ID” parameter is equal to zero for standard L2TP control messages. On the other hand, a non-zero “vendor ID” may identify a control message as a custom control message associated with a party identified by the “vendor ID.” For a given party, the “vendor ID” is determined as an IANA (internet assigned numbers authority) assigned SMI (structure and identification of management information for TCP/IP-based internets) network management private enterprise code (e.g., the private enterprise code associated with AOL Time Warner is 9671). In short, a custom control message type to transport modem session diagnostic information may be defined based on a uniquely valued “attribute type” and “vendor ID” parameter pair.

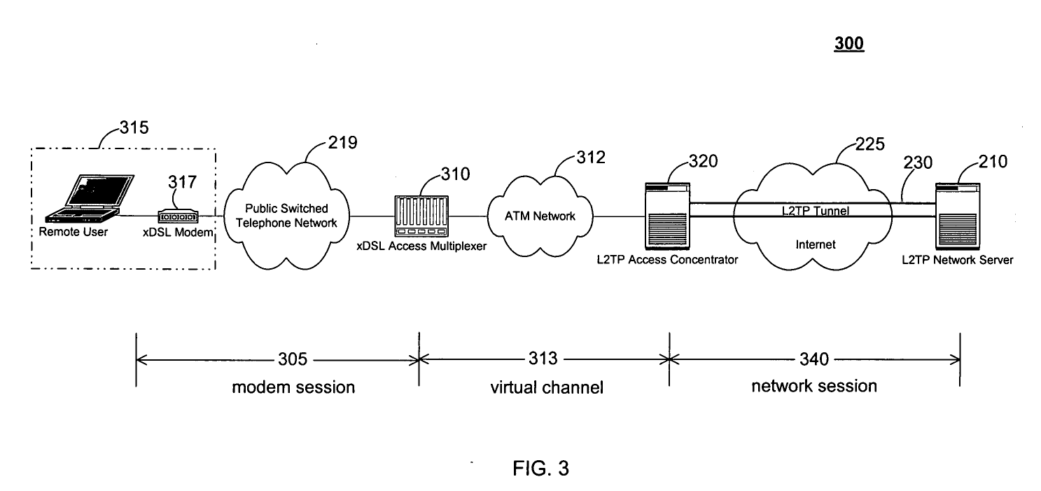

FIG. 3 illustrates a system 300 that generally is similar to the system of FIG. 2. For brevity, only those aspects of system 300 distinct from the system of FIG. 2 are described.

A remote user 315 connects with a LAC 320 using a digital subscriber line (xDSL). The remote user 315 uses an xDSL modem 317 of the remote user 315 to establish an active modem session 305 with an xDSL multiplexer (DSLAM) 310 over the PSTN 219. The DSLAM 310 completes the connection to the LAC 320 by transferring to the LAC 320 using an ATM network 312.

Unlike in the system of FIG. 2, in system 300, the DSLAM 310 terminates the active modem session (i.e., the DSLAM 310 provides the modem session endpoint opposite the remote user 315) rather than the LAC 320. Hence, in system 300, the DSLAM 310 is configured to determine the diagnostic information related to the active modem session 305. The DSLAM 310 may be configured to determine the diagnostic information similarly to the gateway service 120 of FIG. 1.

The DSLAM 310, however, is not logically positioned to provide the diagnostic information to the LNS 210 in the manner described with respect to FIG. 2 (e.g., using L2TP tunneling). Rather, the DSLAM 310 is configured to provide the diagnostic information to the intermediately located LAC 320 using the ATM network 312. To provide the diagnostic information to the LAC 320, the DSLAM 310 establishes a virtual channel 313 to the LAC 320 over the ATM network 312. The virtual channel 313 is associated with the active modem session 305. The DSLAM 310 communicates the diagnostic information to the LAC 320 using the established virtual channel 313 of the ATM network 312. After receiving the diagnostic information, the LAC 320 communicates the diagnostic information to the LNS 210 over the internet 225 using a network session 340 that includes, for example, an L2TP tunnel 230 as described with respect to FIG. 2.

FIG. 3 illustrates that, in general, communication between the user 315 using the modem session 305 and the online service 210 may include any number of intermediate communication sessions (e.g., the virtual channel 313, the network session 340). Nevertheless, the disclosure shows generally that diagnostic information of the active modem session 305 of the user 315 maybe communicated to the online service 210 using those intermediate communication sessions, irrespective of their number. Moreover, the online service 210 similarly may use the methods and apparatus described to obtain diagnostic information of one or more of the intermediate communications sessions (e.g., the virtual channel 313).

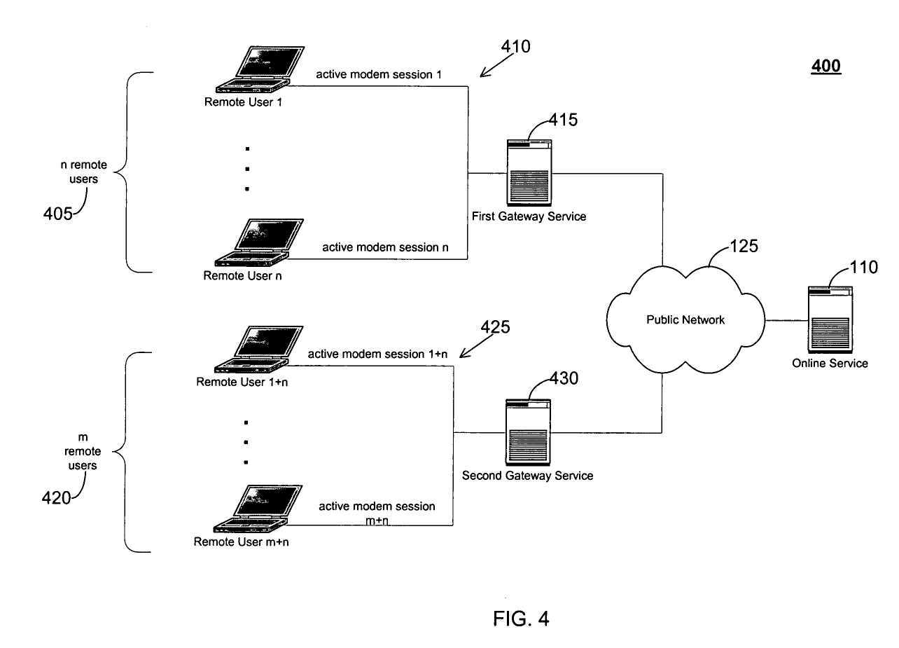

Referring to FIG. 4, a system 400 is illustrated that is similar generally to the system of FIG. 1. A first group 405 of n remote users is shown with associated active modem sessions 410 accessing a first gateway service 415. A second group 420 of m remote users also is shown with associated active modem sessions 425 accessing a second gateway service 430. Each of the first gateway service 415 and the second gateway service 430 determines diagnostic information related to one or more of the active modem sessions 410 and/or to one or more of the active modem sessions 425, respectively. In the manner described with respect to FIG. 1, the first gateway service 415 and the second gateway service 425 communicate the diagnostic information to the online service 110 over the public network 125. The online service 110 uses the diagnostic information to identify a fault relating to remote access to the online service 110.

For example, the online service 110 may determine based on diagnostic information of a single current modem session that a modem of a remote user is faulty, that a gateway service is faulty, and/or that a modem communication channel is defective.

Where the online service 110 is configured to be accessed by many remote users, as in FIG. 4, the benefit provided to the online service 110 by the diagnostic information may exhibit a network effect. In other words, the benefit the diagnostic information provides to the online service 110 may increase significantly (e.g., exponentially) relative to the number of remote users accessing the online service using active modem sessions.

For example, the online service 110 may aggregate diagnostic information associated with a plurality of active modem sessions (e.g., some or all of the active modem sessions 410 and 425), and may analyze (e.g., using statistical analysis) the aggregated diagnostic information to determine faults that complexity renders otherwise difficult to identify. The online service 110 may determine based on its analysis of the diagnostic information that all modem sessions 425 associated with, for example, the second gateway service 430 are of poor quality. Based on the determination that all modem sessions of the second gateway service 430 are of poor quality, the online service 110 may determine that the second gateway service 430 is faulty. Alternatively, if many but not all of the modem sessions 425 associated with the second gateway service 430 are of poor quality, the online service 110 may determine that a communication channel common to the poor quality modem sessions is faulty (e.g., a shared portion of the PSTN), and/or that the second gateway service 430 is faulty.

Should all active modem connections 410 and 425 of the first gateway service 415 and the second gateway service 430 be determined as of poor quality based on associated diagnostic information, the online service 110 may determine that an element common to the first gateway service 415 and the second gateway service 430 is faulty, such as, for example, a common communication path and/or an interface of the first gateway service 415 and the second gateway service 430 to the online service 110.

Upon detecting a fault, the online service 110 may make a maintenance determination to resolve or alleviate the fault. For example, the online service 110 automatically may inform a repair service of the fault while intelligently rerouting communications to an alternate system configured to avoid the fault. The online service also may inform users potentially affected by the fault of an expected impact of the fault and of action planned to resolve the fault.

In fashion similar to that described above, diagnostic information of other types of active modem sessions (e.g., an active cable modem session, an active wireless modem session) may be provided to and used by an online service.

Other implementations are within the scope of the following claims.

What is claimed is:

1. A communication system, the system comprising:
a modem session endpoint configured as a conduit for active modem communications involving a user and configured to determine diagnostic information related to the active modem communications, wherein the active modem communications include information directed to an online service;
a tunneling protocol including a diagnostic information message format; and
a gateway configured to communicate the diagnostic information with the modem session endpoint and to communicate the diagnostic information to the online service using the diagnostic information message format of the tunneling protocol.

2. The system of claim 1 wherein the gateway comprises an access concentrator.

3. The system of claim 1 wherein the gateway further comprises an access multiplexer.

4. The system of claim 1 wherein the tunneling protocol comprises a layer 2 tunnel protocol.

5. The system of claim 1 wherein the tunneling protocol comprises a point-to-point tunneling protocol.

6. The system of claim 1 further comprising a maintenance mechanism configured to use the diagnostic information automatically to detect and diagnose a communication fault.

7. The system of claim 6 wherein the maintenance mechanism is configured further to detect and to diagnose the communication fault based on additional diagnostic information related to active modem communications of other users.

8. A communication system, the system comprising:
a communication service configured to use one or more tunneling protocol to receive diagnostic information related to active modem communications of each of a plurality of users; and
a diagnostic service configured to aggregate the diagnostic information and to detect and to diagnose a network fault automatically based on the aggregated diagnostic information.

9. The system of claim 8 further comprising a maintenance service configured automatically to correct the network fault.

10. The system of claim 8 further comprising a maintenance service configured automatically to circumvent the network fault.

11. The system of claim 8 further comprising a maintenance service configured automatically to correct and to circumvent the network fault.

12. A computer program stored on a computer readable medium or a propagated signal, the computer program comprising:
a modem code segment that causes a modem to communicate an active modem communication, wherein the active modem communication includes information directed to an online service;
a tunnel code segment that causes a computer of the online service to communicate using a tunneling protocol; and
a gateway code segment that causes a gateway computer to:
communicate with the modem;
determine diagnostic information related to the active modem communication; and
communicate with the computer of the online service to provide the diagnostic information to the computer of the online service.

13. The computer program of claim 12 wherein the tunnel code segment further comprises an L2TP code segment that causes the computer of the online service to communicate using a layer 2 tunnel protocol.

14. The computer program of claim 12 wherein the tunnel code segment further comprises a PPTP code segment that causes the computer of the online service to communicate using a point-to-point tunneling protocol.

15. The computer program of claim 12 wherein the tunnel code segment further comprises an L2F code segment that causes the computer of the online service to communicate using layer 2 forwarding.

16. The computer program of claim 12 further comprising a maintenance code segment that causes the computer of the online service to use the diagnostic information to detect and to diagnose a network fault.

17. The computer program of claim 16 wherein the maintenance code segment further causes the computer of the online service to detect and to diagnose the network fault based on additional diagnostic information related to active modem communications of other users.

18. A computer program stored on a computer readable medium or a propagated signal, the computer program comprising:
a communication code segment that causes a computer to use one or more tunneling protocol to receive diagnostic information related to active modem communications of each of a plurality of users; and
a diagnostic code segment that causes the computer to aggregate the diagnostic information and to detect and to diagnose a network fault automatically based on the aggregated diagnostic information.

19. The computer program of claim 18 further comprising a maintenance code segment that causes the computer automatically to correct and/or to circumvent the network fault.

20. A method of communicating modem session diagnostic information, the method comprising:
configuring the online service to communicate with a plurality of modems using a plurality of access sessions, each access session comprising a first communication session and a second communication session, wherein the first communication session logically is nearer the online service than the second communication session;
configuring the online service to use the first communication sessions to communicate diagnostic information related to the second communication session; and
configuring the online service to use the diagnostic information to diagnose a communication fault without human intervention.

21. The method of claim 20 further comprising configuring the online service to remedy or to circumvent the communication fault without human intervention.

22. A method of communicating diagnostic information to an online service, the method comprising:
configuring the online service to communicate with a user computer using an access session that comprises a first communication session and a second communication session, wherein the first communication session logically is nearer the online service than the second communication session;
determining diagnostic information related to the second communication session; and
configuring the online service to use the first communication session to communicate diagnostic information determined relative to the second communication session.

23. The method of claim 22 wherein:
the first communication session logically connects a gateway service and an online service; and
the second communication session logically connects the gateway service and a networked device.

24. The method of claim 23 wherein the first communication session comprises a network session and the second communication session comprises an active modem session.

25. The method of claim 22 wherein the first communication session further comprises a tunneling protocol with a diagnostic message, and wherein the first communication session is configured to use the diagnostic information message of the tunneling protocol to communicate the diagnostic information.

26. The method of claim 25 wherein the second communication session includes an active modem session.

27. The method of claim 22 further comprising configuring the online service to use a computer to diagnose a communication fault based on the diagnostic information without human intervention.
